(19) United States
(12) Patent Application Publication
(10) Pub. No.: US 2003/0041628 A1
(43) Pub. Date: Mar. 6, 2003

(54) Furnaces having dual gas screens and methods for operating the same

(76) Inventors: Lindwood A. Bird, Wilmington, NC (US); John M. Jewell, Wilmington, NC (US); David G. Surratt JR., Wilmington, NC (US); Zhenming Wu, Wilmington, NC (US)

Correspondence Address: MYERS BIGEL SIBLEY & SAJOVEC, PO BOX 37428, RALEIGH, NC, 27627, US

(21) Appl. No.: 09/947,306

(22) Filed: Sep. 5, 2001

(51) Int. Cl. C03B 37/02

(52) U.S. Cl. 65/533

(57) ABSTRACT

Furnace assemblies are provided including a furnace defining an internal process chamber extending therethrough. A first gas screen is coupled to the furnace. The first gas screen is configured to introduce a first gas into the internal process chamber at a first end of the furnace. A second gas screen is positioned adjacent to the first gas screen at an opposite end of the first gas screen from the furnace. The second gas screen is configured to introduce a second gas to provide a seal for the first end of the furnace. The furnace may be a draw furnace and the process chamber may be an internal draw chamber.

### FIELD OF THE INVENTION

This invention relates to furnaces, and, more particularly, furnaces for manufacturing optical fibers and methods for using the same.

### BACKGROUND OF THE INVENTION

With the expansion of telecommunications services, there has been a great demand for optical fibers. Optical fibers are typically formed by drawing while heating and melting a transparent optical fiber preform in an optical fiber drawing furnace. Such furnaces typically draw the optical fiber while maintaining a flow of process gas around the optical fiber during processing. Such fiber drawing furnaces further conventionally flow the process gases from an end of the furnace adjacent the preform through to an opposite end of the draw furnace, which direction will generally be referred to herein as a downward flow. Examples of such a draw furnace are described, for example, in U.S. Pat. Nos. 5,848,093 and 5,637,130. It is also known, however, to use an upward flow of process gas in a draw furnace as illustrated in the above-referenced patents.

Draw furnaces generally provide for some form of outlet sealing means to prevent air intrusion into the draw furnace. For example, current optical fiber draw furnaces, which typically flow process gas in a downward direction, may provide a gas screen at the exit portion of the draw furnace as a sealing device. An example of a gas screen is a cylindrical, double wall mechanical device with flanges at both ends for mounting that may be used to supply, for example, inert gas to an optical fiber draw furnace. For a downward flow draw furnace, a single such gas screen may be attached to the bottom end of the draw furnace to introduce sealing gas, which will also flow downstream, to facilitate sealing of the lower end of the draw furnace. More particularly, the gas introduced at the single lower end gas screen need not be the same process gas as flowing through the system in the downward flow draw furnace as it is introduced downstream of the process region of the draw furnace. The gas from the single gas screen may be, for example, a sealing gas that is less expensive to utilize. This may provide for a reduced demand for process gas use during fiber draw in a downward flow optical draw furnace.

Such an approach may create difficulties when used in a process using upward gas flow of process gases during drawing of an optical fiber. More particularly, while a gas screen in such a system may be provided with sufficient flow of process gas to cause such gas to flow both upward through the treatment area as well as downwards to contribute toward sealing the lower end of the draw furnace, an adequate seal will generally not be provided due to the limited desired range of process gas flow rates through the fiber draw process chamber. In other words, it may not be possible to provide a sufficiently high flow rate for acceptable sealing without undesirably high flow rates in the process chamber. More particularly, for a graphite furnace, sealing quality is typically measured by carbon monoxide concentration that may result from reaction of oxygen (air) with carbon furnace components. Conventional graphite draw furnaces using a single gas screen have been shown to experience a carbon monoxide concentration measured at about 70 parts per million (ppm), which concentration level may not satisfy process requirements.

### SUMMARY OF THE INVENTION

In various embodiments of the present invention, furnace assemblies are provided including a furnace defining an internal process chamber extending therethrough. A first gas screen is coupled to the furnace. The first gas screen is configured to introduce a first gas into the internal process chamber at a first end of the furnace. A second gas screen is positioned adjacent to the first gas screen at an opposite end of the first gas screen from the furnace. The second gas screen is configured to introduce a second gas to provide a seal for the first end of the furnace. The furnace may be a draw furnace and the process chamber may be an internal draw chamber.

In other embodiments of the present invention, the first end of the draw furnace is a downstream end of the draw furnace and the draw furnace has an upstream end opposite from the downstream end. The process gas from the first gas screen flows into the internal draw chamber and from the downstream end to the upstream end of the draw furnace so as to pass between a preform in the internal draw chamber and an inner wall of the draw furnace defining the internal draw chamber while the preform is heated. The sealing gas from the second gas screen may, in such embodiments, flow downstream from the downstream end of the draw furnace so as to reduce introduction of contaminant gases into the internal draw chamber while the preform is heated.

In further embodiments of the present invention, a flow controller is provided that controls a flow rate of the process gas from the first gas screen and a flow rate of the sealing gas from the second gas screen. The flow rates may be controlled to provide a desired flow rate of the process gas from the downstream end to the upstream end of the draw furnace (or a desired internal furnace pressure) and to provide a desired flow rate of the sealing gas from the second gas screen downstream from the downstream end of the draw furnace so as to reduce introduction of contaminant gases into the internal draw chamber while the preform is heated.

In other embodiments of the present invention, an orifice member is provided positioned between the first gas screen and the second gas screen. The orifice member includes a central opening having an area selected to provide a desired pressure drop across the orifice member so as to limit the flow of sealing gas through the first gas screen and to limit the flow of processing gas through the second gas screen. A muffle may also be coupled to the downstream end of the draw furnace and the first gas screen may be coupled to a downstream end of the muffle and the second gas screen may be coupled to a downstream end of the first gas screen.

In further embodiments of the present invention, draw furnace assemblies for manufacturing optical fiber are provided including a draw furnace defining an internal draw chamber extending therethrough. A first gas screen is positioned adjacent a downstream end of the draw furnace. The first gas screen is configured to introduce a process gas into the internal draw chamber at the downstream end of the draw furnace. A second gas screen is positioned adjacent to the first gas screen at an opposite end of the first gas screen from the draw furnace. The second gas screen is configured to introduce a sealing gas to provide a seal for the downstream end of the draw furnace. The sealing gas may be a heavier gas than the process gas. A flow controller is provided that controls a flow rate of the process gas from the first gas screen and a flow rate of the sealing gas from the second gas screen to provide a desired flow rate of the process gas from the downstream end to an upstream end of the draw furnace and to provide a desired flow rate of the sealing gas from the second gas screen downstream from the downstream end of the draw furnace so as to reduce introduction of contaminant gases into the internal draw chamber while a preform positioned in the internal draw chamber is heated.

In other embodiments of the present invention, methods are provided for providing a desired gas flow in a draw furnace for manufacturing optical fiber. A first gas screen is provided positioned adjacent a first end of the draw furnace. A second gas screen is provided positioned adjacent an end of the first gas screen opposite from the draw furnace. A process gas is injected into the draw furnace through the first gas screen at a process gas flow rate. A sealing gas is injected through the second gas screen at a sealing gas flow rate. The process gas flow rate and the sealing gas flow rate are selected to provide a desired flow rate of the process gas from the downstream end to an upstream end of the draw furnace and to provide a desired flow rate of the sealing gas from the second gas screen downstream from the downstream end of the draw furnace so as to reduce introduction of contaminant gases into the draw furnace while a preform positioned in the draw furnace is heated. For example, for a graphite furnace, the process gas flow rate and the sealing gas flow rate may be selected to provide a carbon monoxide concentration in the draw furnace while the preform is heated of less than about 50 parts per million (ppm) or an oxygen concentration of less than about 25 ppm.

### BRIEF DESCRIPTION OF THE DRAWINGS

FIG. 1 is a schematic, cross-sectional view of a draw furnace assembly for forming an optical fiber according to embodiments of the present invention.

FIG. 2 is a flowchart illustrating operations for providing a desired gas flow in a draw furnace for manufacturing an optical fiber according to embodiments of the present invention.

### DETAILED DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of members, layers and regions are exaggerated for clarity. Like numbers refer to like elements throughout. It will be understood that when an element such as a member layer, region or substrate is referred to as being “on,” “connected to” or “coupled to” another element, it can be directly on, directly connected to or directly coupled to the other element, or intervening elements also may be present. In contrast, when an element is referred to as being “directly on,” “directly connected to” or “directly coupled to” another element, there are no intervening elements present.

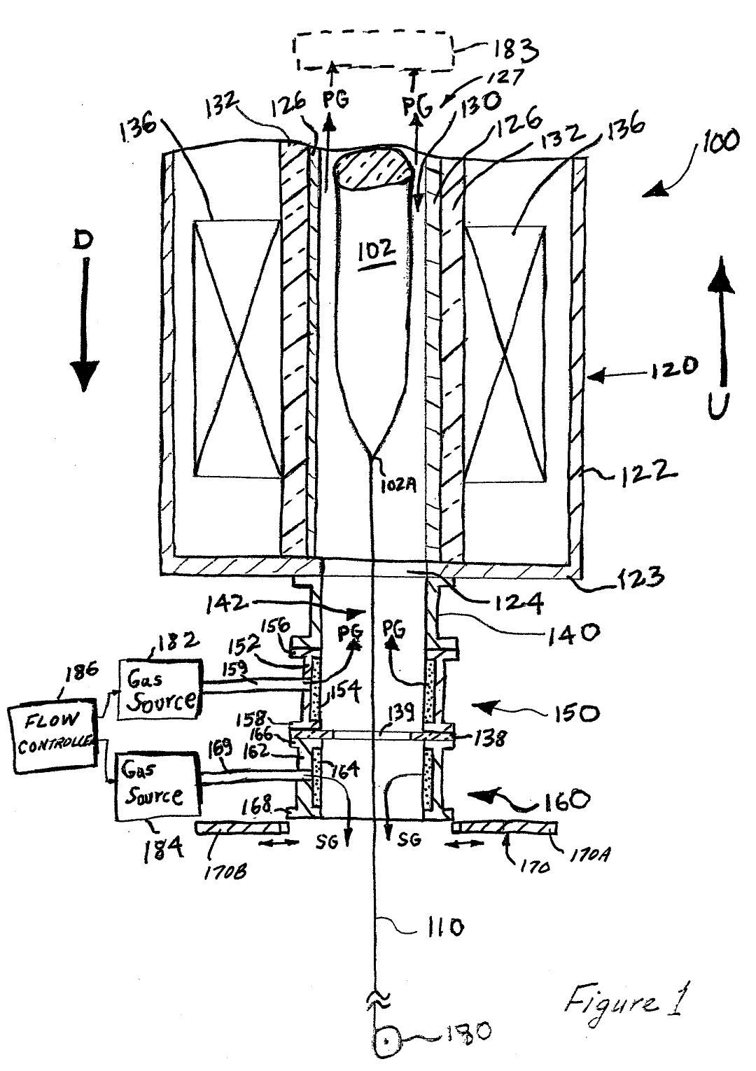

With reference to FIG. 1, a draw furnace assembly 100 according to embodiments of the present invention is shown therein. It is to be understood that, while described herein with reference to a draw furnace, the present invention may be more generally utilized with any suitable furnace including a housed internal chamber in which a process takes place, such as a draw furnace or a reaction chamber. The assembly 100 includes generally a draw furnace 120, a muffle 140, a first gas screen 150, a second gas screen 160, an orifice plate 138 and a tractor station 180. The assembly 100 may be used to form a drawn optical fiber 110 from a glass preform or blank 102, for example. The tractor station 180 serves to control and maintain a desired diameter of the fiber 110.

The glass preform 102 is preferably formed of a doped silica glass. The preform 102 may be formed such that either the core or the cladding (if present) of the drawn fiber is doped or such that both the core and the cladding of the drawn fiber are doped. The silica glass may be doped with one or more of germanium and germanium and fluorine. Other suitable dopants may be used as well. Methods and apparatus for forming the preform 102 are well known and will be readily appreciated by those of skill in the art from the description herein.

The draw furnace 120 includes a housing 122 having a lower end 123 thereof serving as the exit wall of the draw furnace 120. An annular susceptor 126 (that may be, for example, formed of zirconium, graphite or other suitable metal, such as a refractory and/or precious metal that may have a high melting point (above about 2000° C.) and be electrically conductive) extends through the draw furnace 120 and defines an annular passage and an internal draw chamber 130. The internal draw chamber 130 includes an upper section adapted to receive and hold the glass preform 102 and a lower section through which the drawn fiber 110 passes as it is drawn off of the preform 102. The lower section of the passage 130 communicates with an opening 124 in the lower end 123 of the housing 122. An annular insulator 132 and an induction coil 136 surround the susceptor 126. The draw furnace 120, as described and illustrated, is merely exemplary of suitable furnaces and it will be appreciated by those of skill in the art that furnaces of other designs and constructions, for example, using other types of heating mechanisms, may be employed.

The muffle 140 is secured to the lower end of the housing 122, for example, by a plurality of threaded bolts or other fastening means. A rubber O-ring or other sealing means may be provided between the housing 122 and the muffle 140. The muffle 140 defines a passage 142 aligned with the internal draw chamber 130 of the draw furnace 120.

The assembly 100, as shown in FIG. 1, further includes a first gas screen 150 coupled through the muffle 140 to the draw furnace 120. As shown in the simplified representation of FIG. 1, the first gas screen 150 includes an annular housing 152 and an upper flange 156 and a lower flange 158. A diffusing element 154 is shown that receives a flow of gas through an inlet 159 from a first gas source 182. The diffusing element 154 may be simply an annular chamber or passages defined, for example, by a double walled housing or may be a screen, porous material or other diffusing means as will be understood by those of skill in the art. The porous material of the gas screen may be stainless steel, inconel or other selected material based on operating environmental conditions. The pore size may be about 0.5 mirometer or may be larger or smaller based on selected pressure drop or flow rate criteria for particular application environments. The gas screen may also be a manifold type with ports spaced around the annulus of the manifold to provide gas flow. The first gas screen 150 is, thus, configured to introduce a first gas into the internal draw chamber 130 of the draw furnace 120 at a first or lower end 123 of the draw furnace 120 through the opening 124. The first gas is illustrated in FIG. 1 as a process gas (PG). The process gas PG flows from the first gas screen through the lower or downstream end opening 124 of the draw furnace 120 and through the internal draw chamber 130 from the downstream end to the upstream end of the draw furnace so as to pass in an upward (U) direction between the preform 102 and an inner wall defined by the susceptor 126 of the draw furnace 120. Note that, as used herein, upward/upstream (U) and downward/downstream (D) are defined relative to the draw direction of the optical fiber 110.

The second gas screen 160, as shown in the embodiments of FIG. 1 includes an annular housing 162 having an upper flange 166 and a lower flange 168. A diffuser element 164 is provided in the second gas screen 160 coupled to an inlet 169 which, in turn, connects to a gas source 184. Thus, the second gas screen 160 is positioned adjacent to the first gas screen 150 on an opposite end of the first gas screen 150 from the draw furnace 120. The second gas screen 160 is configured to introduce a second gas, shown as a sealing gas (SG) in FIG. 1, to provide a seal for the downstream or lower end 123 of the draw furnace 120. While shown as a separate process gas (PG) and sealing gas (SG) in FIG. 1, it is to be understood that the first gas and the second gas, respectively, from the gas source 182 and the gas source 184 may be the same gas and a single gas source may be used and coupled to both the first and second gas screens 150, 160.

In particular embodiments of the present invention, the process gas is an inert gas. The process gas (PG) may be helium, nitrogen, argon, a mixture of helium, nitrogen or argon or other suitable gas or gas mixture selected for use during processing of an optical fiber in a process chamber. In alternative embodiments of the present invention, the process gas may be a reactive gas, such as CO, CO₂, Cl₂, O₂, H₂, D₂ or other suitable reactive gas. The sealing gas (SG) may be nitrogen, argon, a mixture of nitrogen and argon or other suitable gas or gas mixture selected to seal a process chamber. The sealing gas may be a heavier gas than the process gas. In particular embodiments, the process gas is helium and the sealing gas is argon.

The sealing gas (SG) as illustrated in FIG. 1, flows downstream from the lower end 123 of the draw furnace 120 so as to reduce introduction of contaminant gases, such as oxygen, nitrogen or other contaminants that may be found in air, into the internal draw chamber 130 while a preform 102 is heated. The sealing gas may also limit the flow of process gas exiting the downstream side of the furnace. As schematically illustrated in FIG. 1, it will be understood by those of skill in the art that a pump 183 may also be coupled to the upstream end of the internal draw chamber 130 to move the process gas (PG) from the downstream end to the upstream end of the internal draw chamber 130, as illustrated by the upstream (U) arrow in FIG. 1, in a controlled manner.

Also shown in the embodiments of FIG. 1 is an orifice member 138 positioned between the first gas screen 150 and the second gas screen 160 in accordance with various embodiments of the present invention. The orifice member 138 includes a central opening 139 having an area that may be selected to provide a desired pressure drop across the orifice member 138 so as to limit the flow of the sealing gas (SG) through the first gas screen 150 and to limit the flow of the process gas (PG) through the second gas screen 160. The area of the central opening 139 may also be variable in real time in particular embodiments, such as with an IRIS type orifice. In other embodiments of the present invention, the orifice member 138 is not included. The flanges of the respective members 140, 150, 160 illustrated in FIG. 1 are to be understood as providing a means for coupling the respective members in series so as to define a path through which the optical fiber 110 passes after being drawn from the preform 102. Thus, for example, the muffle 140 is shown as coupled to the downstream end 123 of the draw furnace 120 and the first gas screen 150 is shown coupled to the downstream end of the muffle 140 with the second gas screen 160 coupled to a downstream end of the first gas screen 150 through the orifice member 138.

The embodiments illustrated in FIG. 1 further include a door member 170 coupled to the downstream end of the second gas screen 160. The components of the door member 170 may be slid towards each other by any suitable means such as a motor to close or restrict the downstream end of the furnace. The door member 170 may be used to close the system mechanically when the furnace is idle. Preferably, however, each door member 170a, 170b includes a half circle formed in the end thereof such that when closed, they together form a circle of small diameter surrounding the fiber 110 such that air infiltration into gas seal 160 is minimized.

Also shown in FIG. 1 is a flow controller 186. The flow controller 186 controls a flow rate of the process gas (PG) from the first gas screen 150 and a flow rate of the sealing gas (SG) from the second gas screen 160. Thus, a desired flow rate of the process gas (PG) from the downstream end 123 to the upstream end 127 of the draw furnace 120 (in other words, in the upstream U direction as shown in FIG. 1) is provided. The flow controller 186 further provides a desired flow rate of the sealing gas (SG) from the second gas screen 160 downstream from the downstream end 123 of the draw furnace 120 so as to reduce introduction of contaminant gases, such as oxygen, and to the internal draw chamber 130 while the preform 102 is heated.

The tensioning station 180 may be any suitable device for controlling the tension in the drawn fiber 110. The tensioning device 180 may include a microprocessor that receives input from one or more fiber tension and/or diameter sensors and is operative to address the tension of the fiber 110 as needed. Other draw apparatus sub-components are not shown for clarity, such as diameter sensors, and coating and curing apparatus.

The assembly 100 may be used in the following manner to manufacture an optical fiber 110. The induction coil 136 or other suitable heating member (such as a resistance element) is operated to heat the tip 102A of the preform 102 to a selected draw temperature T_{D}. Preferably, the draw temperature T_{D} is in the range of between about 1800° C. and about 2100° C. More preferably, the draw temperature T_{D} is in the range of between about 1850° C. and about 1950° C. The tip 102A is maintained at the selected draw temperature T_{D} so that the drawn fiber 110 is continuously drawn off of the tip 102A in a downward direction D. The fiber 110 is maintained at a selected draw tension F_{D} as described above by the tensioning device 180 or other suitable means. An upstream flow at a desired rate of a process gas (PG) is provided from the first gas screen 150. A downstream flow at a desired rate of a sealing gas (SG) is provided from the second gas screen 160.

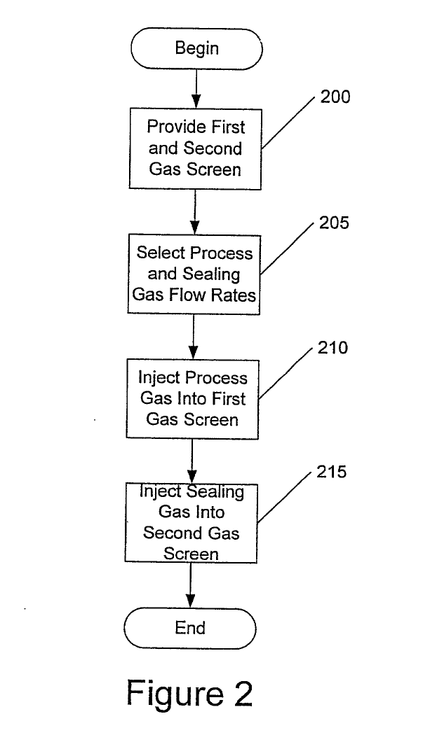

Operations related to providing a desired gas flow in a draw furnace for manufacturing optical fiber according to embodiments of the present invention will now be further described with reference to the flowchart illustration of FIG. 2. A first gas screen is positioned adjacent to a first end of the draw furnace and a second gas screen is positioned adjacent an end of the first gas screen opposite from the draw furnace (block 200). Such a configuration is illustrated, for example, by the respective positioning of the draw furnace 120, the first gas screen 150 and the second gas screen 160 shown in FIG. 1. However, it is to be understood that, while shown for an upstream flow of process gas in FIG. 1 with the gas screens on the downstream end 123 of the draw furnace 120, the assembly and method aspects of the present invention are not so limited and may be used, for example, with the first and second gas screens 150, 160 coupled to the upstream end 127 of the draw furnace 120 in various embodiments of the present invention.

A process gas flow rate and a sealing gas flow rate are selected to provide a desired flow rate of the process gas from the downstream end to an upstream end of the draw furnace and to provide a desired flow rate of the sealing gas from the second gas screen in a downstream direction so as to reduce introduction of contaminant gases into the draw furnace while a preform position in the draw furnace is heated (block 205). The process gas is injected into the draw furnace through the first gas screen at the process gas flow rate (block 210). The sealing gas is injected through the second gas screen at the sealing gas flow rate (block 215). In particular embodiments, operations at block 215 may include selecting the process gas flow rate and the sealing gas flow rate to provide a carbon monoxide concentration in the draw furnace while a preform is heated of less than about 50 parts per million (ppm) or an oxygen concentration of about 25 ppm. The process gas flow rate may be between about 10 and about 40 standard liters per minute (SLPM). The sealing gas flow rate may be between about 5 and about 20 SLPM.

Thus, as described with reference to FIGS. 1 and 2, various embodiments of the present invention provide separate flow paths for possibly different gases used for processed and sealing gases. The gas screen positioned closest to the draw furnace may provide the process gas while the gas screen positioned further from the draw furnace may provide the sealing gas. Through the use of two separate gas supplies, a heavier gas may be used as a sealing gas that may provide better results for a draw furnace assembly orientation as shown in FIG. 1 where gravity may facilitate preferential flow of the heavier sealing gas in the downstream direction and flow in the upstream direction for the process gas. With the embodiments illustrated in FIG. 1, in various experiments, a carbon monoxide concentration has been measured at about 35 ppm, which is approximately 50% lower than was observed for a single-screen configuration under the same test conditions.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as preforming the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A furnace assembly, comprising:
a furnace defining an internal process chamber extending therethrough;
a first gas screen coupled to the furnace, the first gas screen being configured to introduce a first gas into the internal process chamber at a first end of the furnace; and
a second gas screen positioned adjacent to the first gas screen at an opposite end of the first gas screen from the furnace, the second gas screen being configured to introduce a second gas to provide a seal for the first end of the furnace.

2. The furnace assembly of claim 1 wherein the furnace comprises a draw furnace and wherein the process chamber comprises an internal draw chamber.

3. The furnace assembly of claim 2 wherein the first gas and the second gas are the same.

4. The furnace assembly of claim 2 wherein the first gas comprises a process gas and the second gas comprises a sealing gas that is different from the process gas.

5. The furnace assembly of claim 4 wherein the first end of the draw furnace comprises a downstream end of the draw furnace and wherein the draw furnace further comprises an upstream end opposite from the downstream end and wherein the process gas from the first gas screen flows into the internal draw chamber and from the downstream end to the upstream end of the draw furnace so as to pass between a preform in the internal draw chamber and an inner wall of the draw furnace defining the internal draw chamber while the preform is heated.

6. The furnace assembly of claim 5 wherein the sealing gas from the second gas screen flows downstream from the downstream end of the draw furnace so as to at least one of reduce introduction of contaminant gases into the internal draw chamber while the preform is heated and limit flow of process gas from the downstream end of the draw furnace while the perform is heated.

7. The furnace assembly of claim 6 further comprising a pump coupled to the draw furnace, wherein the pump moves the process gas from the downstream end to the upstream end of the internal draw chamber.

8. The furnace assembly of claim 6 wherein the process gas includes an inert gas.

9. The furnace assembly of claim 8 wherein the process gas is selected from a group consisting of helium, nitrogen, argon and a mixture of helium, nitrogen or argon and wherein the sealing gas is selected from a group consisting of nitrogen, argon and a mixture of nitrogen and argon.

10. The furnace assembly of claim 8 wherein the sealing gas is a heavier gas than the process gas.

11. The furnace assembly of claim 10 wherein the process gas comprises helium and wherein the sealing gas comprises argon.

12. The furnace assembly of claim 4 further comprising a flow controller that controls a flow rate of the process gas from the first gas screen and a flow rate of the sealing gas from the second gas screen to provide a desired flow rate of the process gas from the downstream end to the upstream end of the draw furnace and to provide a desired flow rate of the sealing gas from the second gas screen downstream from the downstream end of the draw furnace so as to reduce introduction of contaminant gases into the internal draw chamber while the preform is heated.

13. The draw furnace assembly of claim 12 further comprising an orifice member positioned between the first gas screen and the second gas screen, the orifice member including a central opening having an area selected to provide a desired pressure drop across the orifice member so as to limit the flow of sealing gas through the first gas screen and to limit the flow of processing gas through the second gas screen.

14. The furnace assembly of claim 12 further comprising a muffle coupled to the downstream end of the draw furnace and wherein the first gas screen is coupled to a downstream end of the muffle and wherein the second gas screen is coupled to a downstream end of the first gas screen.

15. The furnace assembly of claim 14 further comprising an orifice member positioned between the first gas screen and the second gas screen, the orifice member including a central opening having an area selected to provide a desired pressure drop across the orifice member so as to limit the flow of sealing gas through the first gas screen and to limit the flow of processing gas through the second gas screen.

16. The furnace assembly of claim 4 wherein the process gas includes a reactive gas.

17. A draw furnace assembly for manufacturing optical fiber comprising:
a draw furnace defining an internal draw chamber extending therethrough;
a first gas screen positioned adjacent a downstream end of the draw furnace, the first gas screen being configured to introduce a process gas into the internal draw chamber at the downstream end of the draw furnace;
a second gas screen positioned adjacent to the first gas screen at an opposite end of the first gas screen from the draw furnace, the second gas screen being configured to introduce a sealing gas to provide a seal for the downstream end of the draw furnace, the sealing gas comprising a heavier gas than the process gas; and
a flow controller that controls a flow rate of the process gas from the first gas screen and a flow rate of the sealing gas from the second gas screen to provide a desired flow rate of the process gas from the downstream end to an upstream end of the draw furnace and to provide a desired flow rate of the sealing gas from the second gas screen downstream from the downstream end of the draw furnace so as to reduce introduction of contaminant gases into the internal draw chamber while a preform positioned in the internal draw chamber is heated.

18. The draw furnace assembly of claim 17 wherein the process gas comprises helium and wherein the sealing gas comprises argon.

19. A method for providing a desired gas flow in a draw furnace for manufacturing optical fiber, the method comprising the steps of:
providing a first gas screen positioned adjacent a first end of the draw furnace;
providing a second gas screen positioned adjacent an end of the first gas screen opposite from the draw furnace;
injecting a process gas into the draw furnace through the first gas screen at a process gas flow rate;
injecting a sealing gas through the second gas screen at a sealing gas flow rate; and
selecting the process gas flow rate and the sealing gas flow rate to provide a desired flow rate of the process gas from the downstream end to an upstream end of the draw furnace and to provide a desired flow rate of the sealing gas from the second gas screen downstream from the downstream end of the draw furnace so as to reduce introduction of contaminant gases into the draw furnace while a preform positioned in the draw furnace is heated.

20. The method of claim 19 wherein the process gas includes an inert gas.

21. The method of claim 20 wherein the process gas is selected from a group consisting of helium, nitrogen, argon and a mixture of helium, nitrogen or argon and wherein the sealing gas is selected from a group consisting of nitrogen, argon and a mixture of nitrogen and argon.

22. The method of claim 20 wherein the sealing gas is a heavier gas than the process gas.

23. The method of claim 19 wherein the process gas comprises helium and wherein the sealing gas comprises argon.

24. The method of claim 19 wherein the step of selecting the process gas flow rate and the sealing gas flow rate further comprises the step of selecting the process gas flow rate and the sealing gas flow rate to provide at least one of a carbon monoxide concentration in the draw furnace of less than about 50 parts per million (ppm) while the preform is heated and an oxygen concentration of less than about 25 ppm while the perform is heated.
